(19) United States
(12) Patent Application Publication
(10) Pub. No.: US 2015/0213965 A1
(43) Pub. Date: Jul. 30, 2015

(54) METHOD OF MAKING A EUROPIUM ION DOPED WORKING ELECTRODE

(71) Applicant: National Kaohsiung University of Applied Science, Kaohsiung City (TW)

(72) Inventors: Wein-Duo Yang, Kaohsiung City (TW); Hsin-Yi Liu, Kaohsiung City (TW)

(73) Assignee: National Kaohsiung University of Applied Science, Kaohsiung City (TW)

(21) Appl. No.: 14/165,644

(22) Filed: Jan. 28, 2014

(51) Int. Cl. H01G 9/20

(52) U.S. Cl. CPC H01G 9/2031

(57) ABSTRACT

A method of making a europium ion doped working electrode, which comprises the following steps: anodizing a Ti foil to obtain an electrode body; dipping the electrode body into an acid solution, which contains 0.035 to 0.045 M of europium ions, followed by thermal treating in a closed system under 100° C. to 180° C. and calcining. Based on the steps above, the fabrication of a working electrode is simplified and the cost is decreased. Also, a europium ion doped working electrode that can enhance the photoelectric conversion efficiency of a back side illuminated TiO₂-based DSSC to 153.7 times is obtained.

### BACKGROUND OF THE INVENTION

1. Field of the Invention

The present invention relates to a method of making a working electrode, and particularly relates to a method of making a europium ion doped working electrode which is applicable to a titanium oxide based dyed-sensitized solar cell (TiO₂-based DSSC).

2. Description of the Prior Art(s)

As technology advances, energy conservation, environmental protection, and reduction of environmental pollution have received significant attention. The development of green renewable energy and solutions of the environmental problems are urgent. Recently, researches on green renewable resources such as hydro, tidal and solar energy have been conducted in many countries. Endless and inexhaustible solar energy has become an important energy to solve the energy crisis and environmental pollution.

Nowadays, silicon semiconductors made solar cells have already been mass-produced and applied; however, the fabrication of silicon semiconductors made solar cells is so complicated and costly that its application is restricted. To solve this problem, TiO₂-based dyed-sensitized solar cells, which are low-cost with simple process and low pollution, are proposed in M. Grätzel. et al. Nat. 414, 338 (2001).

As shown in FIG. 1, a TiO₂-based DSSC comprises a working electrode 10, a counter electrode 20 and an electrolyte layer 30. The working electrode 10 comprises a working substrate 11 and a TiO₂ nanotube array layer 12, wherein the TiO₂ nanotube array layer 12 is formed on an inner surface of the working substrate 11 and comprises dye molecules. The counter electrode 20 corresponds in position to the working electrode 10. The counter electrode 20 comprises a counter substrate 21 and a platinum conductive layer 22, wherein the counter substrate 21 is fluorine-doped tin oxide, which is light-transmissive. The platinum conductive layer 22 is formed on an inner surface of the counter substrate 21 and corresponds in position to the TiO₂ nanotube array layer 12. The electrolyte layer 30 is located between the TiO₂ nanotube array layer 12 and the platinum conductive layer 22, wherein the electrolyte layer 30 comprises reduction-oxidation couples.

Depending on the illumination mechanism of TiO₂-based DSSCs, TiO₂-based DSSCs are classified into front side illuminated TiO₂-based DSSCs and back side illuminated TiO₂-based DSSCs.

The working substrate of a front side illuminated TiO₂-based DSSC is made of light transmissive materials such as fluorine-doped tin oxide. When a front side illuminated TiO₂-based DSSCs is in operation, sunlight is incident directly through the working substrate into the front side illuminated TiO₂-based DSSC.

There are two main fabrication methods of the working electrode for the front side illuminated TiO₂-based DSSC.

The first method comprises steps of: anodizing a Ti plate and forming a TiO₂ nanotube array layer on a surface of the Ti plate, separating the TiO₂ nanotube array layer from the Ti plate; and adhering the TiO₂ nanotube array layer to the working substrate, which is light transmissive, and obtaining the working electrode for the front side illuminated TiO₂-based DSSC, as mentioned in Q. W. Chen. et al. J. Phys. Chem. C. 113, 6310 (2009), H. Park. et al. Sol. Energy Mater. Sol. Cells. 95, 184 (2011), C. Rho. et al. J. Phys. Chem. C. 116, 7213 (2012), J. Qiu. et al. J. Mater. Chem. 21, 5062 (2011) and B. X. Lei. et al. J. Phys. Chem. C. 114, 15228 (2010).

The second fabrication method of the working electrode for the front side illuminated TiO₂-based DSSC is disclosed in G. K. Mor. et. al. Nano Lett. 6, 215 (2006) and T. Stergiopoulos. et. al. Nanotech. 20, 365601 (2009). The second fabrication method of the working electrode for the front side illuminated TiO₂-based DSSC comprises steps of: sputtering a Ti thin film on a surface of the working substrate; and anodizing the Ti thin film to form a TiO₂ nanotube array layer and obtaining the working electrode.

However, the first fabrication method of the working electrode for the front side illuminated TiO₂-based DSSC and the second fabrication method of that mentioned above are complicated; thus, additional expenses and time are needed.

On the contrary, the working substrate of a back side illuminated TiO₂-based DSSC is not made of light transmissive materials, but made of a Ti plate instead. As disclosed in J. M. Macak. et. al. Electrochem. Commun. 7, 1133 (2005), H. Wang. et. al. Appli. Phys. Lett. 89, 023508 (2006), B. C, O'Regan. et. al. J. Phys. Chem. C. 111, 14001 (2007), P. Roy. et. al. Electrochem. Commun. 11, 1001 (2009), M. K. Parvez. et. al. Chem. Phys. Lett. 495, 69 (2010), S. H. Kang. et. al. J. Phys. Chem. C. 111, 9614 (2007), C. T. Yip. et. al. Appli. Phys. A. 92, 589 (2008), J. T. Kim. et. al. Sol. Energy Mater. Sol. Cells. 95, 336 (2011), J. W. et. al. Chem. Mater. 22, 579 (2010), D. H. Kim. et al. J. Am. Chem. Soc. 130, 16454 (2008), Y. L. Xie. et al. Electrochem. Commun. 17, 34 (2012) and W. Zhu. et al. Electrochim. Acta. 56, 2618 (2011), by anodizing a Ti plate directly, a Ti-made working substrate and a TiO₂ nanotube array layer that is located on a surface of the Ti-made working substrate are obtained, and the working electrode of a back side illuminated TiO₂-based DSSC is fabricated. As the working electrode of the back side illuminated TiO₂-based DSSC is fabricated by anodizing a Ti plate directly, the fabrication of the working electrode of the back side illuminated TiO₂-based DSSC is simpler than the fabrication of the working electrode of the front side illuminated TiO₂-based DSSC mentioned above. The fabrication cost of the back side illuminated TiO₂-based DSSC is also lower than the fabrication cost of the front side illuminated TiO₂-based DSSC.

However, since the Ti-made working substrate is not light transmissive, as the back side illuminated TiO₂-based DSSC is in operation, sunlight is incident through the counter electrode and the electrolyte to arrive at the TiO₂ nanotube array and excite the dye molecules. And as sunlight passes through the counter electrode and the electrolyte, the light degradation occurs, the magnitude of sunlight that is absorbed by the dye molecules is decreased. Therefore, the photoelectric conversion efficiency of the back side illuminated TiO₂-based DSSC is lowered.

To overcome the shortcoming of the back side illuminated TiO₂-based DSSC mentioned above, the present invention provides a method for making a europium ion doped working electrode to mitigate or obviate the aforementioned problem.

### SUMMARY OF THE INVENTION

Given that the aforesaid drawbacks of the prior art such as high fabrication cost and low photoelectric conversion efficiency, the objective of the present invention is to provide a method for making a europium ion doped working electrode, which is capable of enhancing the photoelectric conversion efficiency of the back side illuminated TiO₂-based dye-sensitized solar cell.

The method for making a europium ion doped working electrode in accordance with the present invention includes steps of:

anodizing a titanium foil to obtain an electrode body, the electrode body comprising a Ti-made working substrate and a titanium oxide (TiO₂) nanotube array layer located on a surface of the Ti-made working substrate;

dipping the electrode body into an acid solution, the acid solution containing 0.035 to 0.045 M of europium ions based on the volume of the acid solution;

thermal treating the electrode body and the acid solution in a closed system under a temperature ranging from 100° C. to 180° C. to obtain an as-doped working electrode; and

calcining the as-doped working electrode to obtain an europium ion doped working electrode.

Preferably, the acid solution comprises sulfate ions, nitrate ions, or carbonate ions.

Preferably, the step of thermal treating the electrode body and the acid solution in a closed system under a temperature ranging from 100° C. to 180° C. to obtain an as-doped working electrode comprises thermal treating the electrode body and the acid solution in a closed system under a temperature ranging from 100° C. to 180° C. for 2 hours to 8 hours to obtain the as-doped working electrode.

In accordance with the present invention, the step of calcining the as-doped working electrode to obtain the europium ion doped working electrode comprises calcining the as-doped working electrode under 300° C. to 700° C. to obtain the europium ion doped working electrode.

Preferably, the step of calcining the as-doped working electrode to obtain the europium ion doped working electrode comprises calcining the as-doped working electrode under 300° C. to 700° C. for 1 hour, 2 hours, 4 hours, 8 hours or 12 hours to obtain the europium ion doped working electrode.

Preferably, the crystalline structure of the TiO₂ nanotube array layer is anatase phase.

In accordance with the present invention, the step of thermal treating the electrode body and the acid solution in a closed system under a temperature ranging from 100° C. to 180° C. to obtain an as-doped working electrode comprises steps of:

thermal treating the electrode body and the acid solution in a closed system under a temperature ranging from 100° C. to 180° C. to obtain a thermal treated working electrode; and

washing the thermal treated working electrode to obtain the as-doped working electrode.

Preferably, the step of washing the thermal treated working electrode to obtain the as-doped working electrode comprises:

washing the thermal treated working electrode with deionized water to obtain the as-doped working electrode.

In accordance with the present invention, the step of anodizing a Ti foil to obtain an electrode body comprises steps of:

setting the Ti foil and a cathode in an electrolyte, wherein a distance between the Ti foil and the cathode ranges from 1 centimeter to 2.5 centimeters; and

anodizing the Ti foil in the electrolyte to obtain the electrode body.

In accordance with the present invention, the step of anodizing a Ti foil to obtain an electrode body comprises anodizing the Ti foil in an ethylene glycol based electrolyte to obtain the electrode body.

Preferably, the ethylene glycol based electrolyte contains 0.1 wt % to 0.5 wt % of ammonium fluoride based on the weight of the ethylene glycol based electrolyte.

Preferably, the ethylene glycol based electrolyte contains 0.1 vol % to 4 vol % of water based on the volume of the ethylene glycol based electrolyte.

Preferably, the step of anodizing a Ti foil to obtain an electrode body comprises anodizing the Ti foil in the ethylene glycol based electrolyte with an anodizing potential ranging from 20 volts to 60 volts to obtain the electrode body.

Preferably, the step of anodizing a Ti foil to obtain an electrode body comprises anodizing the Ti foil with an anodizing potential ranging from 20 volts to 60 volts for an anodizing period ranging from 4 hours to 12 hours to obtain the electrode body.

Preferably, the step of anodizing a Ti foil to obtain an electrode body comprises steps of:

anodizing the Ti foil in the ethylene glycol based electrolyte; and

stirring the ethylene glycol based electrolyte by a stirring rate of 100 revolutions per minute to 200 revolutions per minute to obtain the electrode body.

More preferably, the ethylene glycol based electrolyte is stirred by a stirring rate of 125 revolutions per minute to 175 revolutions per minute to obtain the electrode body.

In accordance with the present invention, the step of anodizing a Ti foil in an ethylene glycol based electrolyte to obtain the electrode body comprises steps of:

anodizing the Ti foil in the ethylene glycol based electrolyte to obtain a pre-electrode body;

sonicating the pre-electrode body in deionized water for 5 minutes to 15 minutes to obtain a cleaned electrode body; and

drying the cleaned electrode body to obtain the electrode body.

Preferably, the step of drying the cleaned electrode body to obtain the electrode body comprises steps of:

drying the cleaned electrode body to obtain a dried electrode body; and

calcining the dried electrode body under 300° C. to 800° C. for 1 hour to 12 hours to obtain the electrode body.

Accordingly, the residual electrolyte and impurities are removed from the pre-electrode body, and thus, the cleanness of the electrode body is ensured.

In comparison with the prior art, the method for making a europium ion doped working electrode of the present invention has the following advantages:

1. As the electrode body is provided by anodizing a Ti foil directly, the fabrication of the working electrode is simplified and the cost is decreased.

2. By dipping the electrode body into an acid solution, which contains 0.035 to 0.045 M of europium ions, followed by thermal treating in a closed system under 100° C. to 180° C. and calcining, a europium ion doped working electrode that enhances the photoelectric conversion efficiency of a back side illuminated TiO₂-based dye-sensitized solar cell is obtained.

Other objectives, advantages and novel features of the invention will become more apparent from the following detailed description when taken in conjunction with the accompanying drawings.

### BRIEF DESCRIPTION OF THE DRAWINGS

FIG. 1 is a schematic diagram of a TiO₂-based dyed-sensitized solar cell;

FIG. 2 is a flow diagram of the method of providing an electrode body containing a Ti-made working substrate and a TiO₂ nanotube array layer located on a surface of the Ti-made working substrate;

FIG. 3 is a flow diagram of the method of making a europium ion doped working electrode;

FIG. 4 is X-ray diffraction (XRD) spectra of the TiO₂ nanotube array layers of the present invention, wherein curves (a) to (f) are the XRD spectra of the TiO₂ nanotube array layers of the third to the eighth embodiments of the present invention respectively, peaks marked with symbol A represent the anatase phase peaks of TiO₂;

FIGS. 5A to 5F are the SEM images of the TiO₂ nanotube array layer from the third to the eighth embodiments of the present invention, respectively;

FIG. 6 is the emission spectrum of the TiO₂ nanotube array layer of the third embodiment of the present invention;

FIG. 7 shows the excitation spectra of the TiO₂ nanotube array layers of the present invention, wherein curves (a) to (e) are the excitation spectra of the TiO₂ nanotube array layer of the third to the eighth embodiments of the present invention respectively.

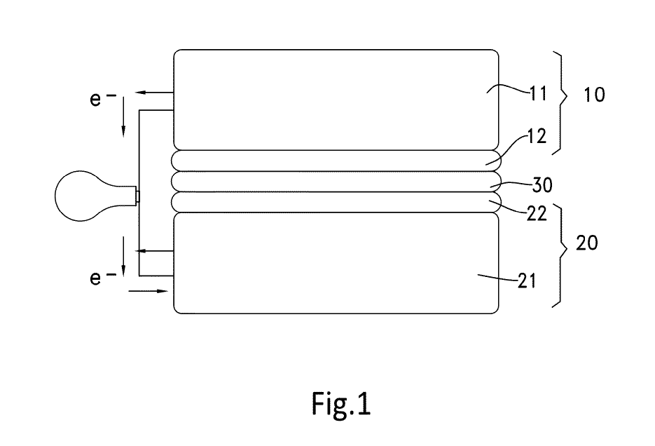

### DETAILED DESCRIPTION OF THE PREFERRED EMBODIMENTS

For a better understanding about the technical features of the present invention and its effect, and for implements in accordance with the disclosures of the specification, preferred embodiment, details and figures are further shown as follows.

### First Embodiment

The present embodiment demonstrates the materials involved in the present invention.

To implement the present invention, the following materials can be used.
a. Titanium (Ti) foil: 99.5%, purchased from Summit-tech Resource Corp.
b. Acetone ((CH₃)₂CO): 95%, purchased from Echo Chemical Corp., LTD.
c. Ethanol (C₂H₆O): 95%, purchased from Echo Chemical Corp., LTD.
d. Ammonium fluoride (NH₄F): 98+%, purchased from Echo Chemical Corp., LTD.
e. Ethane-1,2-diol (C₂H₆O₂): 99.6%, purchased from Echo Chemical Corp., LTD.
f. Europium(III) nitrate (Eu(NO)₃): 99.9%, purchased from Alfa Aesar.

### Second Embodiment

The present embodiment demonstrates instruments involved in the present invention.
a. Direct circuit power supply, manufactured by Good Will Instrument Corp., the product type was GPQ-3030D.
b. High temperature oven, manufactured by Carbolite Limited, the product type was RHF-1600.
c. Spin coater, manufactured by Laurell Technologies Corp., the product type was WS-400A-6NPP/LITE.
d. Autoclave, manufactured by Parr Instrument Company, the product type was Parr 4843.
e. X-ray Diffractometer (XRD), manufactured by ÷PANalytical and the product type was X'Pert PRO. X-ray was formed by passing the light source through a copper target (Kα=1.54 Å with a voltage of 45 kV and a current of 20 mA to 40 mA), and the scan range was from 20 degrees to 60 degrees and the scan rate was 1.36 degrees per minute.
f. Field-emission scanning electron microscope (FE-SEM), manufactured by JEOL Ltd., and the product type was JSM-6700F. The FE-SEM is equipped with an energy dispersive spectroscopy (EDS) system.
g. Photoluminescence (PL), manufactured by Hitachi Instruments and the product type was F-4500.
h. Solar simulator, manufactured by Yamashita Denso and the product type was YSS-E40. The solar simulator provided spectra in accordance with the AM1.5G of ASTM spectral irradiance.

### Third Embodiment

The present embodiment is related to a method for providing an electrode body containing a Ti-made working substrate and a TiO₂ nanotube array layer located on a surface of the Ti-made working substrate.

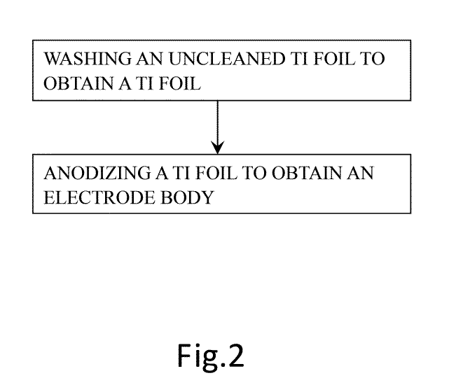

With reference to FIG. 2, the method of the present embodiment for providing an electrode body containing a Ti-made working substrate and a TiO₂ nanotube array layer located on a surface of the Ti-made working substrate included steps as follows:
a. Washing an uncleaned Ti foil to obtain a Ti foil: after cutting a purchased Ti foil, an uncleaned Ti foil which was 2 cm×2.5 cm in size was obtained. After rinsing the uncleaned Ti foil by acetone for several times and sonicating the rinsed uncleaned Ti in deionized water for 20 min, a Ti foil was obtained.
b. Anodizing a Ti foil to obtain an electrode body: a C₂H₆O₂ based electrolyte was deployed in a reaction tank, wherein the C₂H₆O₂ based electrolyte contained NH₄F of 0.3 wt % and water of 2 vol %. The Ti foil and a platinum plate were set in the C₂H₆O₂ based electrolyte and corresponding in position to each other. The distance between the Ti foil and the platinum plate was 1.5 cm. The Ti foil and the platinum plate were connected to a power supply separately, wherein the Ti foil was the anode and the platinum plate was the cathode. After the Ti foil was anodized under room temperature and a constant voltage of 40 volts (V) for 8 hours, a pre-electrode body was obtained. The pre-electrode body was sonicated in deionized water for 5 minutes to obtain a cleaned electrode body. The cleaned electrode body was dried in an oven to remove the residual C₂H₆O₂ electrolyte and impurities. Then the pre-electrode body was heated to 500° C. with a heating rate of 10° C. per minute, and then calcined under 500° C. for 2 hours in a high temperature oven and an electrode body containing a Ti-made working substrate and a TiO₂ nanotube array layer located on a surface of the Ti-made working substrate was obtained.

### Fourth Embodiment

The present embodiment related to a method for making a europium ion doped working electrode.

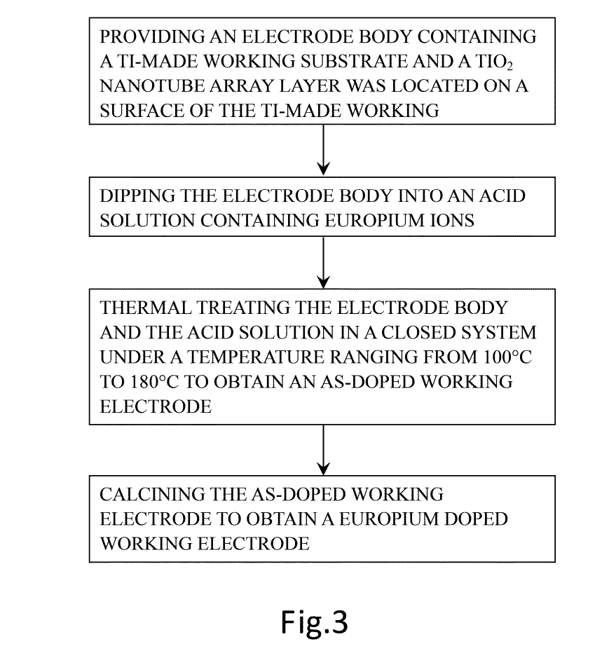

With reference to FIG. 3, the method of the present embodiment for making a europium ion doped working electrode includes steps as follows:
a. Providing an electrode body containing a Ti-made working substrate and a TiO₂ nanotube array layer located on a surface of the Ti-made working substrate: the electrode body of the present embodiment was prepared by the method as described in the third embodiment.
b. Dipping the electrode body into an acid solution containing europium ions: 10 mol of Eu(NO₃)₃ purchased from Alfa Aesar was mixed with 0.1 L of deionized water and xx mol of NH₄F purchased from Echo Chemical Corp., LTD, and an nitric acid solution containing europium ions (Eu³⁺) of 0.01 M based on the volume of the acid solution was obtained. The electrode body was dipped into the nitric acid solution.
c. Thermal treating the electrode body and the acid solution in a closed system under a temperature ranging from 100° C. to 180° C. to obtain an as-doped working electrode: the electrode body and the nitric acid solution were placed in a closed system under 180° C. for 2 hours and an thermal treated working electrode was obtained. Then the thermal treated working electrode was washed by deionized water and an as-doped working electrode was obtained.
d. Calcining the as-doped working electrode to obtain a europium ion doped working electrode: the as-doped working electrode was calcined under 500° C. for 2 hours; then a europium ion doped working electrode was obtained. In the present embodiment, the closed system was an autoclave manufactured by Parr Instrument Company.

### Fifth Embodiment

The present embodiment is related to a method for making a europium ion doped working electrode.

The method for making a europium ion doped working electrode of the present embodiment is similar to that of the fourth embodiment. The difference between the present invention and the fourth embodiment is that the nitric acid solution contained Eu³⁺ of 0.02 M based on the volume of the acid solution

### Sixth Embodiment

The present embodiment is related to a method for making a europium ion doped working electrode.

The method for making a europium ion doped working electrode of the present invention is similar to that of the fourth embodiment. The difference between the present invention and the fourth embodiment is that the nitric acid solution contained Eu³⁺ of 0.03 M based on the volume of the acid solution.

### Seventh Embodiment

The present embodiment is related to a method for making a europium ion doped working electrode.

The method for making a europium ion doped working electrode of the present embodiment is similar to that of the fourth embodiment. The difference between the present embodiment and the fourth embodiment is that the nitric acid solution contained Eu³⁺ of 0.04 M based on the volume of the acid solution.

### Eighth Embodiment

The present embodiment is related to a method for making a europium ion doped working electrode.

The method for making a europium ion doped working electrode of the present embodiment is similar to that of the fourth embodiment. The difference between the present embodiment and the fourth embodiment is that the nitric acid solution contained Eu³⁺ of 0.05 M based on the volume of the acid solution.

### Ninth Embodiment

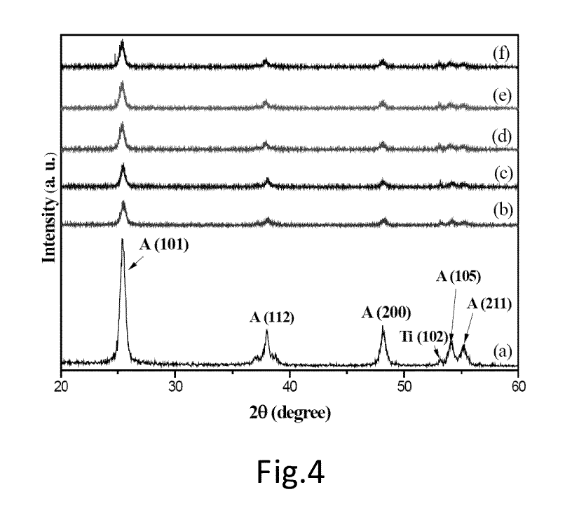

The present embodiment is related to the analyses of crystalline structures by x-ray diffractometer (XRD). The crystalline structure of the TiO₂ nanotube array layer of the third embodiment was analyzed for comparison. Also, the crystalline structures of the TiO₂ nanotube array layer of the Eu³⁺ doped working electrode from the fourth to the eighth embodiments were analyzed. The results were shown in FIG. 4.

As shown in FIG. 4, the characteristic peaks of the TiO₂ nanotube array layer of the third embodiment at 20 of 25.1°, 37.7°, 48.1°, 53.9°, and 55° could be respectively assigned to the (101), (112), (200), (105) and (211) planes of the anatase phase of TiO₂. The positions of characteristic peaks of the TiO₂ nanotube array layer of the third embodiment were identical to positions of the characteristic peaks of the TiO₂ nanotube array layer of the fourth, the fifth, the sixth, the seventh and the eighth embodiments. No characteristic peak related to europium-contained phase was observed. A conclusion was obtained that the crystalline structures of the TiO₂ nanotube array layers were still anatase structure after doping with the europium ions.

### Tenth Embodiment

The present embodiment is related to analyses of scanning electron microscope (SEM) images of the TiO₂ nanotube array layers of the third to the eighth embodiments. The present embodiment is also related to analyses of composition of the TiO₂ nanotube array layer of the third and the seventh embodiments by energy dispersive spectroscopy (EDS) system.

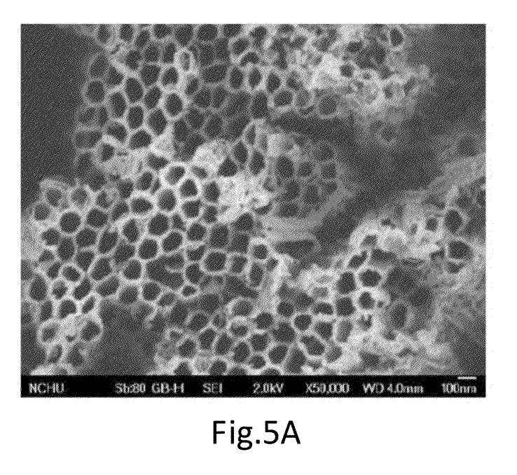

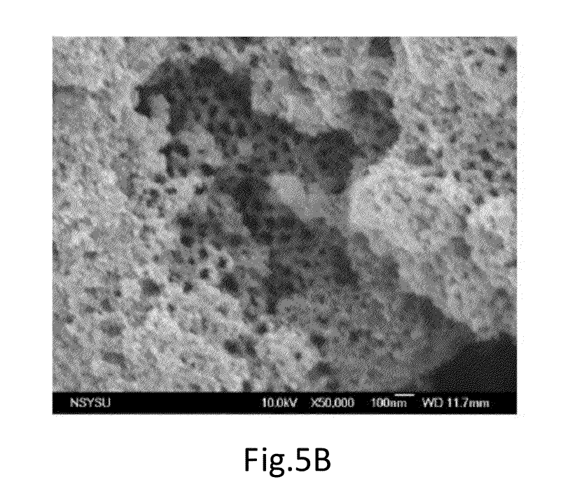

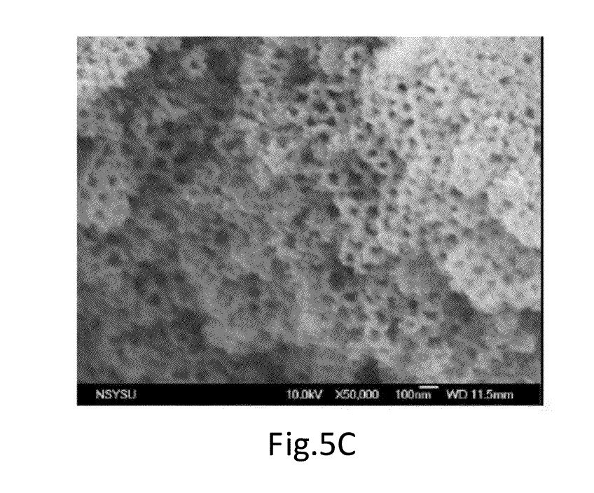

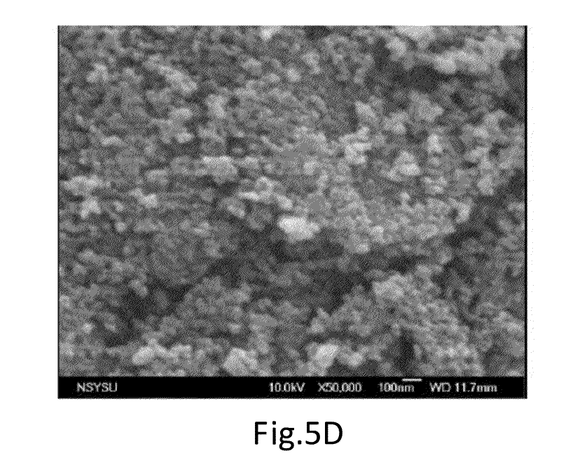

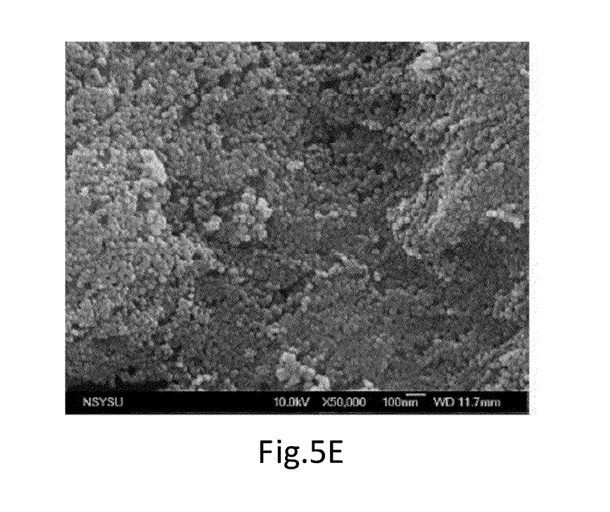

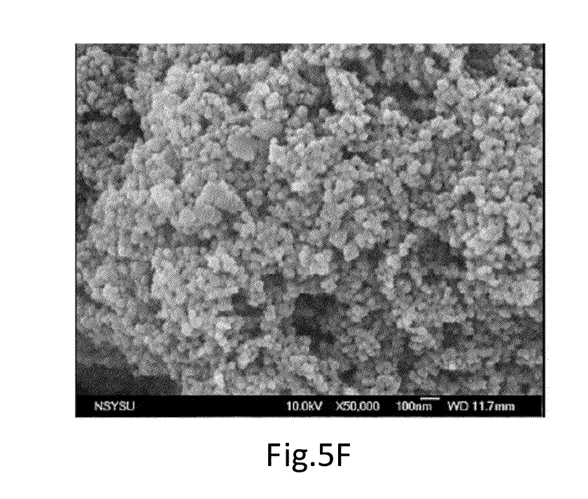

FIGS. 5A to 5F respectively show the SEM images of the TiO₂ nanotube array layer of the third to eighth embodiments. FIG. 5A show the TiO₂ nanotubes of the TiO₂ nanotube array layer of the third embodiment, and the TiO₂ nanotubes had a well-ordered surface morphology and an inner diameter of 100 nm. FIGS. 5B and 5C respectively show the TiO₂ nanotubes of the TiO₂ nanotube array layer from the fourth and the fifth embodiments, wherein the TiO₂ nanotubes of FIGS. 5B and 5C were partly covered with cotton-like objects. FIGS. 5D to 5F respectively show the TiO₂ nanotubes of the TiO₂ nanotube array layer from the sixth to the eighth embodiments, wherein the TiO₂ nanotubes of FIGS. 5D to 5F were fully covered with cotton-like objects.

Table 1 the composition of the TiO₂ nanotube array layer of the third embodiment.

| | Weight percentage | Atomic percentage |
|---|---|---|
| Element | (wt %) | (at %) |
| O | 23.20 | 47.49 |
| Ti | 76.80 | 52.51 |
| Total | 100.00 | 100.00 |

Table 2 the composition of the TiO₂ nanotube array layer of the seventh embodiment.

| | Weight percentage | Atomic percentage |
|---|---|---|
| Element | (wt %) | (at %) |
| O | 31.84 | 69.58 |
| Ti | 29.49 | 21.53 |
| Eu | 38.67 | 8.90 |
| Total | 100.00 | 100.00 |

Tables 1 and 2 respectively show the composition of the TiO₂ nanotube array layer of the third embodiment and the seventh embodiment. As shown in table 1, the TiO₂ nanotube array layer of the third embodiment contains Ti element and O element, indicating the composition of the TiO₂ nanotube array layer of the third embodiment was TiO₂. As shown in table 2, the TiO₂ nanotube array layer of the third embodiment contains Ti element, O element and Eu element, indicating the compositions of the TiO₂ nanotube array layer of the seventh embodiment were TiO₂ and Eu₂O₃.

Based on analyses of SEM images and the analyses of composition by EDS system mentioned above, a conclusion was obtained that the cotton-like objects covered on the surface of TiO₂ nanotube array layers were Eu₂O₃.

### Eleventh Embodiment

The present embodiment is related to analyses of emission spectrum of the TiO₂ nanotube array layer from the third embodiment by photoluminescence (PL).

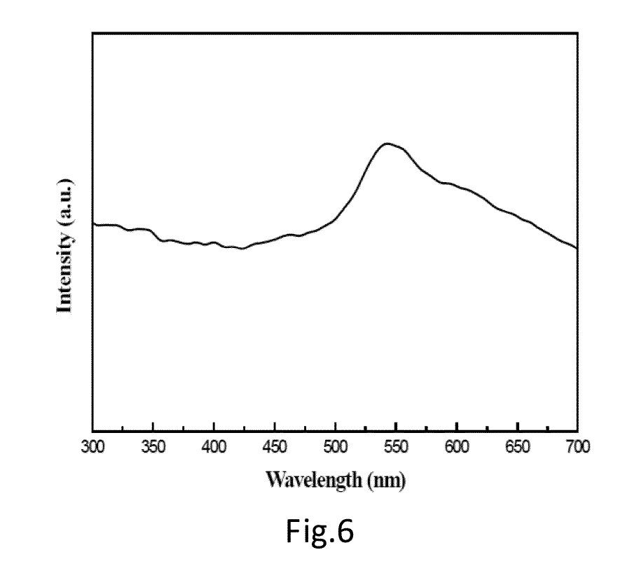

FIG. 6 shows the emission spectrum of the third embodiment. The emission spectrum had an emission peak around 550 nm, which was ascribed to the surface radiative recombination of the TiO₂ nanotube array layer. TiO₂ is an ionic metal oxide, wherein the valence band of TiO₂ is composed by O 2_{P} orbital and the lowest energy conduction band of TiO₂ is composed by Ti 3_{P} orbital. As a result that Ti⁴⁺ is easily reduced to Ti³⁺, Ti²⁺, and Ti⁺, some energy steps appear in the energy gap width. The energy steps that appear in the energy gap width as fluorescence emission center causes the emission peak in the emission spectrum of the TiO₂ nanotube array layer.

### Twelfth Embodiment

The present embodiment is related to analyses of excitation spectrum of the TiO₂ nanotube array layer from the fourth to the eighth embodiments by photoluminescence (PL). The emission wavelength was 614 nm.

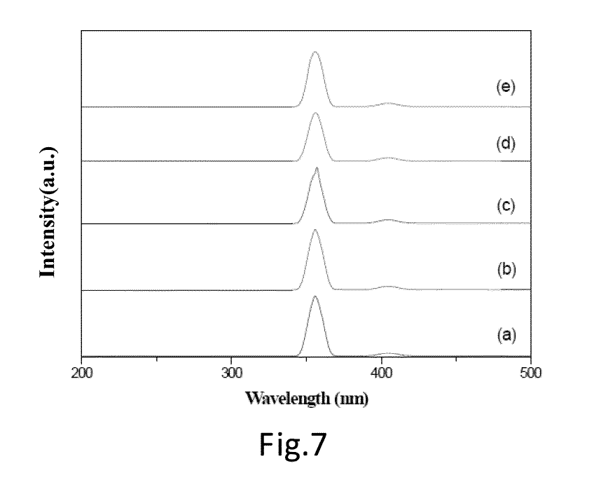

FIG. 7 shows the excitation spectrum from the fourth to the eighth embodiments. The excitation spectrum of the fourth embodiment had a strong excitation peak at 355 nm and a weak excitation peak at 405 nm. The strong excitation peak at 355 nm was the electronic transition of 7F₀-5D₄, indicating energy transfer from Eu³⁺ to TiO₂; in this way, the TiO₂ nanotube array layer could absorb energy effectively. The weak excitation peak at 405 nm was the electronic transition of 7F₀-5D₃ of Eu³⁺ and was ascribed to the direct excitation of Eu³⁺. The excitation spectrums from the fifth to the eighth embodiments were similar to the fourth embodiment while the intensity of excitation peaks degraded from the fourth to the eighth embodiment. As a result, the concentration of Eu³⁺ of the nitric acid solution decreased gradually from the fourth to the eighth embodiment and the intensity of excitation peaks degraded from the fourth to the eighth embodiment, a conclusion was obtained that the doping of europium had influence on the energy absorption of TiO₂ nanotube array layer.

### Thirteenth Embodiment

The present embodiment is related to analyses of photoelectric conversion efficiency (η) of six back side illuminated TiO₂-based DSSCs.

The six back side illuminated TiO₂-based DSSCs were fabricated under identical condition, except that the working electrode source of the six back side illuminated TiO₂-based DSSCs were different. The working electrode source of one of the six back side illuminated TiO₂-based DSSCs was the electrode body of the third embodiment. The working electrode sources of the other five back side illuminated TiO₂-based DSSCs were the europium ion doped working electrodes from the fourth to eighth embodiments respectively. The photoelectric conversion efficiency of the six back side illuminated TiO₂-based DSSCs were measured and shown in table 3.

As shown in table 3, the back side illuminated TiO₂-based DSSC with the electrode body of the third embodiment had a photoelectric conversion efficiency of 0.082%. The back side illuminated TiO₂-based DSSC with the europium ion doped working electrode of the seventh embodiment had a photoelectric conversion efficiency of 0.126%, which was 153.7 times of 0.082%.

TABLE 3
The photoelectric conversion efficiency of back side
illuminated TiO₂-based DSSCs of the thirteenth embodiment

| working electrode source | η (%) |
|---|---|
| the electrode body of the third embodiment | 0.082 |
| the europium ion doped working electrode | 0.048 |
| from the fourth embodiment | |
| the europium ion doped working electrode | 0.067 |
| from the fifth embodiment | |
| the europium ion doped working electrode | 0.069 |
| from the sixth embodiment | |
| the europium ion doped working electrode | 0.126 |
| from the seventh embodiment | |
| the europium ion doped working electrode | 0.030 |
| from the eighth embodiment | |

Enough numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method of making a europium ion doped working electrode, the method comprising the steps of:
anodizing a titanium foil (Ti foil) to obtain an electrode body, the electrode body comprising a Ti-made working substrate and a titanium oxide (TiO₂) nanotube array layer located on a surface of the Ti-made working substrate;
dipping the electrode body into an acid solution, the acid solution containing 0.035 to 0.045 M of europium ions based on the volume of the acid solution; and
thermal treating the electrode body and the acid solution in a closed system under a temperature ranging from 100° C. to 180° C. to obtain an as-doped working electrode; and;
calcining the as-doped working electrode to obtain the europium ion doped working electrode.

2. The method according to claim 1, wherein the acid solution comprises sulfate ions, nitrate ions, or carbonate ions.

3. The method according to claim 1, wherein the step of thermal treating the electrode body and the acid solution in a closed system under a temperature ranging from 100° C. to 180° C. to obtain an as-doped working electrode comprises thermal treating the electrode body and the acid solution in a closed system under a temperature ranging from 100° C. to 180° C. for 2 hours to 8 hours to obtain the as-doped working electrode.

4. The method according to claim 1, wherein the step of calcining the as-doped working electrode to obtain the europium ion doped working electrode comprises calcining the as-doped working electrode under 300° C. to 700° C. to obtain the europium ion doped working electrode.

5. The method according to claim 4, wherein the step of calcining the as-doped working electrode to obtain the europium ion doped working electrode comprises calcining the as-doped working electrode under 300° C. to 700° C. for 1 hours to 12 hours to obtain the europium ion doped working electrode.

6. The method according to claim 5, wherein the crystalline structure of the TiO₂ nanotube array layer is anatase phase.

7. The method according to claim 1, wherein the step of thermal treating the electrode body and the acid solution in a closed system under a temperature ranging from 100° C. to 180° C. to obtain an as-doped working electrode comprises steps of:
thermal treating the electrode body and the acid solution in a closed system under a temperature ranging from 100° C. to 180° C. to obtain a thermal treated working electrode; and
washing the thermal treated working electrode to obtain the as-doped working electrode.

8. The method according to claim 7, wherein the step of washing the thermal treated working electrode to obtain the as-doped working electrode comprises:
washing the thermal treated working electrode with deionized water to obtain the as-doped working electrode.

9. The method according to claim 1, wherein the step of anodizing a Ti foil to obtain an electrode body comprises anodizing the Ti foil in an ethylene glycol based electrolyte to obtain the electrode body.

10. The method according to claim 9, wherein the ethylene glycol based electrolyte contains 0.1 wt % to 0.5 wt % of ammonium fluoride based on the weight of the ethylene glycol based electrolyte.

11. The method according to claim 10, wherein the ethylene glycol based electrolyte contains 0.1 vol % to 4 vol % of water based on the volume of the ethylene glycol based electrolyte.

12. The method according to claim 1, wherein the step of anodizing a Ti foil to obtain an electrode body comprises steps of:
setting the Ti foil and a cathode in an electrolyte, wherein a distance between the Ti foil and the cathode ranges from 1 centimeter to 2.5 centimeters; and
anodizing the Ti foil in the electrolyte to obtain the electrode body.

13. The method according to claim 9, wherein the step of anodizing a Ti foil to obtain an electrode body comprises steps of:
setting the Ti foil and a cathode in the ethylene glycol based electrolyte, wherein a distance between the Ti foil and the cathode ranges from 1 centimeter to 2.5 centimeters; and
anodizing the Ti foil in the ethylene glycol based electrolyte to obtain the electrode body.

14. The method according to claim 9, wherein the step of anodizing a Ti foil to obtain an electrode body comprises anodizing the Ti foil in the ethylene glycol based electrolyte with an anodizing potential ranging from 20 volts to 60 volts to obtain the electrode body.

15. The method according to claim 13, wherein the step of anodizing a Ti foil to obtain an electrode body comprises anodizing the Ti foil in the ethylene glycol based electrolyte with an anodizing potential ranging from 20 volts to 60 volts to obtain the electrode body.

16. The method according to claim 14, wherein the step of anodizing a Ti foil to obtain an electrode body comprises anodizing the Ti foil with an anodizing potential ranging from 20 volts to 60 volts for an anodizing period ranging from 4 hours to 12 hours to obtain the electrode body.

17. The method according to claim 9, wherein the step of anodizing a Ti foil to obtain an electrode body comprises steps of:
anodizing the Ti foil in the ethylene glycol based electrolyte; and
stirring the ethylene glycol based electrolyte by a stirring rate of 100 revolutions per minute to 200 revolutions per minute to obtain the electrode body.

18. The method according to claim 12, wherein the step of anodizing a Ti foil to obtain an electrode body comprises anodizing the Ti foil with an anodizing potential ranging from 20 volts to 60 volts for an anodizing period ranging from 4 hours to 12 hours to obtain the electrode body.

19. The method according to claim 9, wherein the step of anodizing a Ti foil in an ethylene glycol based electrolyte to obtain the electrode body comprises steps of:
anodizing the Ti foil in the ethylene glycol based electrolyte to obtain a pre-electrode body;
sonicating the pre-electrode body in deionized water for 5 minutes to 15 minutes to obtain a cleaned electrode body; and
drying the cleaned electrode body to obtain the electrode body.

20. The method according to claim 16, wherein the step of drying the cleaned electrode body to obtain the electrode body comprises steps of:
drying the cleaned electrode body to obtain a dried electrode body; and
calcining the dried electrode body under 300° C. to 800° C. for 1 hour to 12 hours to obtain the electrode body.
